(19) United States
(12) Patent Application Publication
(10) Pub. No.: US 2007/0286474 A1
(43) Pub. Date: Dec. 13, 2007

(54) System for Grading of Industrial Wood

(76) Inventor: Kim Dralle, Helsinger (DK)

Correspondence Address: KNOBBE MARTENS OLSON & BEAR LLP, 2040 MAIN STREET, FOURTEENTH FLOOR, IRVINE, CA, 92614, US

(21) Appl. No.: 10/590,222

(22) PCT Filed: Feb. 11, 2005
(86) PCT No.: PCT/DK05/00093

§ 371 Date: Jun. 22, 2007

(30) Foreign Application Priority Data
Feb. 20, 2004 (DK) PA 2004 00266

(51) Int. Cl. G06K 9/00

(52) U.S. Cl. 382/154

(57) ABSTRACT

A physical property of an object such as a lying log is determined by taking pairs of images of the opposed end faces and of the exposed upper side from elevated positions relative to the log, so that the images allow stereo imaging of the log seen from both ends. The stereo images are used for determining the physical property of the object. A plurality of logs can be imaged using a single camera or a pair of cameras mounted on a vehicle that is moved relative to the lying logs, or using a single camera or a pair of cameras mounted on a fixed frame and moving the logs past the cameras.

### FIELD OF THE INVENTION

This invention relates to quality grading of logs of wood. Logs are transported from the site of harvesting to a sawmill or a handling, where the logs are size measured and quality graded, in particular for the purpose of determining their usefulness and of fixing a price of the individual logs or of an ensemble of logs.

### BACKGROUND OF THE INVENTION

Today logs are laid parallel in a single layer on a measuring bench (Swedish: mätbänk), and skilled persons perform the measurement of size manually by a caliper and a tape-measure, and the grading by visually inspecting the logs. This is time consuming, and the consistency and repeatability of the grading depends on the person performing the grading.

The purpose of the invention is to solve this problem by providing an automated method of measuring size and grading logs of wood.

### SUMMARY OF THE INVENTION

The invention solves this problem by providing a method and a system for determining a physical property of an object such as a lying log by taking pairs of images of the opposed end faces and of the exposed upper side from elevated positions relative to the object, so that the images allow stereo imaging of the object seen from both ends. The stereo images are used for determining the physical property of the object. A plurality of logs can be imaged using a single camera or a pair of cameras mounted on a vehicle that is moved relative to the lying logs, or using a single camera or a pair of cameras mounted on a fixed frame and moving the logs past the cameras.

The method of the invention is particularly useful for quality grading of logs or pieces of processed wood, but in general physical properties that can be detected by visual inspection or by means of a vision system can also be determined by the invention.

Preferably, the predetermined portion is the upper side of the object, and the object or log can be one of a plurality of objects or logs arranged lying in a side-by-side relationship with each object having its first and second ends and the predetermined portion exposed, and each of the first and second pairs of images includes a plurality of the objects.

Preferably, a first series of first pairs of images is taken that allow stereo imaging of the plurality of objects, and a second series of second pairs of images is taken that allow stereo imaging of the plurality of objects, using a camera that is moved relative to the plurality of objects. Alternatively, the first and second series are taken using a stationary camera and moving the plurality of objects relative to the camera. Each pair of images can be taken using a pair of cameras or using a single camera.

When the objects are logs, the physical property can be selected from the group comprising length, diameter, volume, shape, curvature, surface irregularities, species of tree, percentage of bark, percentage of wood.

### BRIEF DESCRIPTION OF THE DRAWINGS

FIG. 1 illustrates the principle of the invention seen from above. Note, that both length, diameter and shape can vary in any size normal for wood logs, and

FIG. 2 shows the arrangement in FIG. 1 with a camera mounted on a car driving around the measuring bench,

### DETAILED DESCRIPTION OF THE INVENTION

In the following the invention will be described taking the quality grading of logs as an illustrative example.

The System

A specification for an automated vision system is given in the following. The system of the invention is to complete sample measurements of industrial wood at Swedish wood processing industries. The system is intended to substitute for today's manual measurement practices at so-called measuring benches. This requires specification of

1. Operational procedures

2. Data reported by the system.

These two items together then drive the software implementation and the choice of hardware to complete a fully operational system.

1.1 Hardware

1.1.1 Generic set-up

The hardware specification in Table 1.1 is given in conceptual units. The vision system is to be mounted on and operated from a driving car. It should be possible to mount the system on any car or other vehicle having e.g. a roof rack. It should be easy to shift the system form one car to another. The control unit is portable so that it can be brought to the office space for data transmission and further processing.

TABLE 1.1
Hardware units.
Hardware units:

| | |
|---|---|
| 1. | Landmarks (LM): |
| (a) | Mobile visible landmarks. |
| (b) | Storage for landmarks. |
| 2. | Image capturing unit (ICU) mounted on a roof rack: |
| (a) | Stereo vision system based on two cameras. |
| (b) | Lights. |
| 3. | Control unit and user controls (UC) mounted in cabin: |
| (a) | Touch-pad/display and pointing device. |
| (b) | Keyboard. |
| (c) | Processing unit. |
| (d) | GPS unit. |
| 4. | Power supply (PS): |
| (a) | Batteries in ICU and/or outlet in car. |
| 5. | Cables: |
| (a) | Cables to connect items 2, 3 and 4 listed above. |
| 6. | Storage box for hardware. |

1.1.2 Pilot Project at Mörrum, Sweden

A pilot project was conducted at Mörrum, where a prototype of an image-capturing unit mounted on a roof rack and a user control/processing unit in the cabin were used. The cameras are e.g. standard CCD digital cameras and the processing unit is a standard PC equipped with a frame grabber or other suitable interface. A refined and more developed system will have the hardware units assembled in a standardized fashion for ease of use and durability.

1.2 Operational Procedures

1.2.1 General Principle of Operation of the Invention

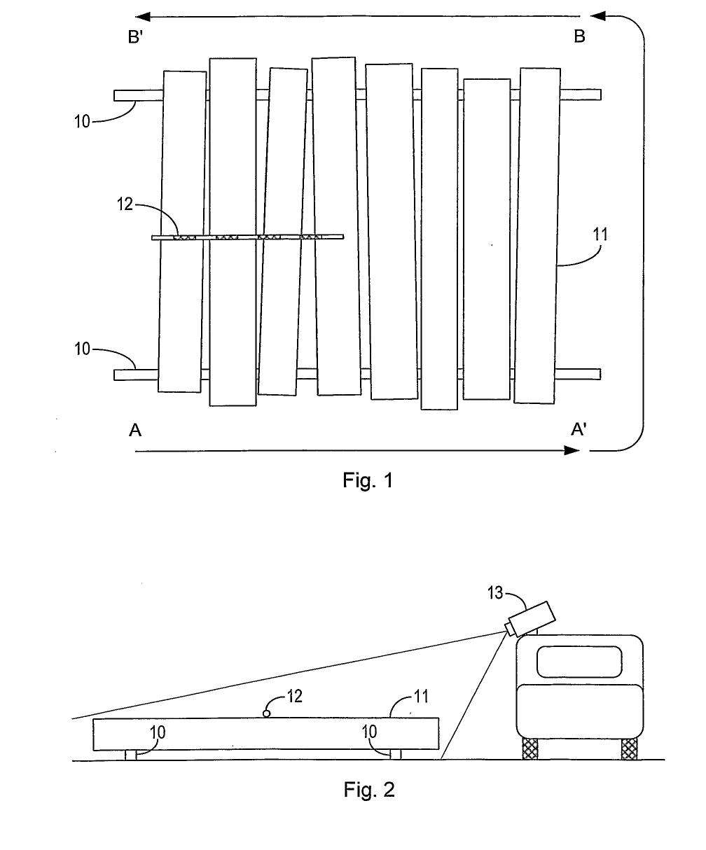

In FIGS. 1 and 2 is shown a measuring bench 10 with logs 11 of different size, shape and length lying on the bench. The size, shape and length of the logs can vary considerably more than what is indicated in FIG. 1. A caliper rod 12 is placed on the logs and extending across several logs. Other callipers such as vertical rods or other geometrical figures can be used, provided they vision system can recognise the callipers as such. A camera 13 is placed at a level above the logs and takes a series of overlapping images showing the end and the upper surface of each log. The core idea of the system is to drive around a measuring bench as illustrated in FIGS. 1 and 2 and continuously capture images of the logs on the measuring bench. First, the car is driven from A to A′ and all logs are imaged from on end. The car then moves to B with the vision system paused. With the vision system activated the car drives from B to B′ and a second series of images of the logs is taken from the opposite end.

The overlapping images are preferably a series of images taken with a single camera moving around the measuring bench, or with a pair of cameras on opposite ends of the log that are moved past the cameras. Or pairs of cameras at different positions can be used to take the overlapping images.

Based on the images and some basic user supervision the system then automatically measures the logs on the measuring bench. The overlapping images allow stereo imaging of the logs that can be used for calculating dimensions and other geometrical properties of the logs such as length, diameter, volume, shape, curvature and surface irregularities. Image analysis methods can be used for recognising properties relating to the quality of the logs such as species of tree, percentage of bark, percentage of wood, damage and percentage of rot.

The measurements are summarized in a measurement report in digital format and on a graphical display. One cycle of driving around the measuring bench includes driving along both sides of the measuring bench in order to measure length and other properties of the logs. Technically a measuring bench will carry one or more truckloads of wood possibly of different species. Each assembly of logs that belong together (by species, truck load, supplier etc.) is referred to as a ‘batch’. Table 1.2 specifies the overall scheme of operation. Selected items are then discussed in detail in successive sections.

TABLE 1.2
Operational procedures.
Operational procedures:

| | |
|---|---|
| 1. | Mount system: |
| (a) | ICU onto roof rack of car |
| (b) | UC in cabin of car |
| (c) | Connect hardware units by cables. |
| (d) | Power on system. |
| 2. | Prepare measuring bench: |
| (a) | Remove snow, dirt and branches from logs |
| (b) | (Re)arrange logs |
| (c) | Place landmarks. |
| 3. | Initialize system: |
| (a) | Enter information identifying batches on measuring bench. |
| (b) | Place car in operating distance from measuring bench at A. |
| (c) | Switch on lights |
| (d) | Adjust field of view of ICU. |
| (e) | Adjust focus and brightness/contrast of ICU cameras. |
| (f) | Mark off upper/lower boundary of measuring bench on display. |
| (g) | Verify initial estimate of logs visually [optional]. |
| 4. | Drive around measuring bench: |
| (a) | Activate vision system. Drive A \| A′. Pause vision system. |
| (b) | Drive to B. Complete initialization steps 3d, 3e, 3f and 3g. |
| (c) | Re-activate vision system. Drive B \| B′. Deactivate vision system. |
| 5. | Verify measurement: |
| (a) | Play image sequence and check that measuring bench is within |
| | images [optional]. |
| (b) | Mark off individual batches |
| (c) | Inspect from sample of images that logs are detected correctly. |
| | That is, check that log ends are detected and matched correctly. |
| | The detection result is superimposed on images. |
| (d) | If case of few mismatches, use point/click interface of UC to |
| | correct mismatches. The system re-estimates the logs. |
| (e) | Iterate over 5c and 5d if necessary. |
| (f) | Enter quality parameters for individual logs or individual batches |
| | from visual inspection of images or physical inspection where |
| | required. |
| (g) | Check summary statistics of measurement report [optional]. |
| (h) | Accept measurement report or discard and start afresh (6). |
| 6. | Iterate over 3, 4 and 5 for each additional load of batches on |
| | measuring bench. That is, if the measuring bench is cleared and |
| | reloaded with batches while the measurement crew is at the site. |
| 7. | Unmount system: |
| (a) | Power off system. |
| (b) | Disconnect hardware units (put cables in storage box). |
| (c) | Unmount ICU and UC [optional]. |
| 8. | Data management: |
| (a) | Bring portable unit of UC to office. |
| (b) | Identify measurement failures. Submit problematic images to |
| | system supplier for check. |
| (c) | Print measurement reports [optional]. |
| (d) | Submit measurement reports to central server. |
| (e) | Free up space on UC [optional]. |

1.2.2 Mount/Unmount System

The cables that connect the ICU and the UC will consist of several parts. Wires for power, control of cameras, control of lights etc. All these are put into one bundle and that connects to the ICU by 1-3 sockets. While operating the system the cable will go through an open window to the cabin. While the system is out of operation driving from one site to another the cable should be stored safely in the storage box.

1.2.3 Prepare Measuring Bench

To facilitate optimal performance of the vision system the log ends of the logs should to a large extent be visible and preferably also the entire outline of each separate log. Therefore rearranging some logs and cleaning up some of the logs may be necessary. If there is more than one batch on the measuring bench leaving some space between each batch is preferable. For maximum precision placing landmarks of known size on the measuring bench is required. The landmarks can be poles with standardized markings that the operator of the system brings with him/her from site to site. Landmarks must be visible to the camera and be of well-defined geometrical form with markings, such as e.g. properly painted traffic-cones. The number, location and orientation of the landmarks should suit the purpose. Observe that landmarks in upright position placed between adjacent batches on the measuring bench can serve as separators.

1.2.4 Initialize System

Initializing the system serves two purposes. One is to label the batches on the measuring bench uniquely for future reference when reports of the measurement results are generated. The labelling can be supported by the GPS system that automatically will give the name and location of the site of the actual measuring bench.

The other main purpose is to start up the image vision system. On the hardware side the orientation of the cameras are adjusted so that logs on the measuring bench can bee seen at full length (field of view). Next the lens system of the cameras is adjusted to give proper focus and brightness/contrast. Both are judged by the operator of the system using the graphical display of the views of the cameras.

On the software side the user may assist the system by marking a region of interest in the camera views. Given this region of interest the software then singles out the individual log and the user verifies the result. While driving along one side of the measuring bench the system automatically tracks the boundaries of the logs on the measuring bench and continuously singles out the individual logs.

1.2.5 Drive Around Measuring Bench

The logs should be visible at their full length and focus should remain sharp on the logs while driving around the measuring bench. The user should therefore make sure that he/she can keep the car at a fairly constant distance (deviations within 1 m) from the measuring bench while driving. The car should be driven at a suitable low speed, about 5-10 km per hour.

1.2.6 Verify Measurement

Having driven all around a measuring bench the system brings the estimated logs to the display for the user to verify that logs are identified correctly. The whole sequence of images is available as a movie to play backwards or forwards. In case the system failed to match up the logs correctly, e.g. due to a broken log, a simple point and click interface will allow the user correct the mismatch. Using a point/click interface or scrolling through the list of logs, images of each log is brought to display and the user can visually assess quality parameters and enter them into the system. If there is more than one batch on the measuring bench and landmarks do not separate the batches the user should also check that batches are separated correctly by the system. Again a simple point and click interface is used to mark off the batch separations.

Finally the user prompts for a measurement report on the display. Based on the report the user decides if the measurement is successful or not. The system has automated procedures to guide the user in finding measurement results of too low accuracy or outside reasonable threshold values.

1.2.7 Quality Assessment of Individual Logs

Having the complete image sequence and logs matched up correctly the user identifies logs that have defects from the images and enter into the system type of defect (rot, damage etc.) and its extent. This may require driving around the measuring bench looking at the logs from the cabin of the car or stepping outside to check a specific log. No new image sequence is taken during the step.

1.2.8 Data Management

The system warns the user of failures or suspicious results and the corresponding images should be further investigated for further processing and refinement of the system. Reports can be printed on paper and transmitted digitally to a central server. The user may delete images from the hard drive of the UC to free up space for future measurements.

1.3 Measurement Report

Today there is a close correspondence between measurement practice and algorithms used to compute statistics from the actual measurements (VMR 1-99, 1-01). Also there are code lists for classification schemes (VMR 1-96).

The vision system operates different from using a caliper and a steel band since the measurements are now indirect. Technically the system builds an internal representation for each log. Based on this representation specific characteristics (length, diameter, etc) are then computed. Since the internal representation does not necessarily mimic a set of top-butt and length measurements the algorithms for computing the characteristics may take a different form than the usual algorithms but will incorporate the usual algorithms when possible. Table 1.3 sets up the categories of information and accuracies the system must provide. The format and coding should comply with today's standards.

1.3.1 Quantities and Format

Given the characteristics computed at the log level, aggregate statistics at the batch level are easily derived. Note that if there is only one batch on a measuring bench then the batch level and measuring bench level will coincide. On the graphical display of the UC a suitable format for each load on a measuring bench is to aggregate at the batch level giving histograms of diameter/length/volume distribution and a table of total number of logs, mean diameter, mean length, total volume and mean volume. The format for printed reports should follow this format with headers that refer to the particular batch. The format of reports for upload should be at the log level, each log being given a unique id that refer back to batch.

1.3.2 Accuracies

The statistics (diameter, volume, etc) computed from the image analysis is considered estimates from a statistical analysis. This analysis provides in itself estimates of the standard error of each quantity.

Measurement report:

| | |
|---|---|
| 1. | Quantities: |
| (a) | Location, time, measurement crew and unique id. |
| (b) | Assortment/quality. |
| (c) | Seller and buyer. |
| (d) | Diameters (butt/top) at individual log level. |
| (e) | Length at individual log level. |
| (f) | Volume at individual log level. |
| (g) | Wood quality parameters at individual log level |
| | based on user's visual inspection. |
| (h) | Curvature. |
| (i) | Bark percentage. |
| (j) | Damage. |
| (k) | Rot. |
| 2. | Accuracies: |
| (a) | Standard error on mean diameter. |
| (b) | Standard error on mean length. |
| (c) | Standard error on mean volume. |
| 3. | Format: |
| (a) | Tables and images on graphical display of UC. |
| (b) | Tables in digital format for printing (HTML/PDF). |
| (c) | Tables in digital format for upload (XML). |

1.4 Quality Monitoring

Besides human supervision of the measurement process (Table 1.2 item 5) the system has automated procedures that guides the user and ensures a high quality of the measurements. These procedures are active both while the system is being operated in the field at a measuring bench and while running the system in the office.

TABLE 1.4
Quality assessment.
Quality assessment:

| | |
|---|---|
| 1. | Routines that identifies outlying summary statistics. |
| 2. | Routines that checks that required accuracies are met. |
| 3. | Routines that keeps track on how much human supervision was |
| | required to match up logs. |
| 4. | Continuous monitoring of operating system from central server. |

1.4.1 Routines that Check that Required Accuracies are Met

In accordance with today's practices the system must meet some minimum accuracies on the estimates. As outlined in Section 1.3.2 it is an inherent feature of the system that standard errors are computed. Given tabular standards or algorithms for the required accuracy it is a straightforward computation to check that the required accuracy is met.

1.5 Maintenance

A functional system is made up of hardware units, software and crew each of which require “maintenance” in its own way. Table 1.5 gives an outline of the generic maintenance. For a specific hardware configuration and software version there will be specific procedures to follow.

TABLE 1.5
Maintenance.
Maintenance:

| | |
|---|---|
| 1. | ICU: |
| (a) | Check that lenses/“windows” are clean. |
| (b) | Check adjustment of focus, shutter time and f/stop |
| | (brightness and contrast). |
| (c) | Check lights. |
| (d) | Check socket for cable. |
| (e) | Calibrate camera from test-field [if required]. |
| 2. | UC: |
| (a) | Keep free space on static storage medium of processing unit. |
| (b) | Check touch-pad/pointing device and keyboard. |
| (c) | Software updates. |
| 3. | Crew: |
| (a) | Education of crew that operates the system. |

1.5.1 Image Capturing Unit and User Control

Clearly maintenance is about mechanical features of each of the hardware components and relates closely to the operational procedures. However, camera calibration to take into account lens distortion of the vision system and verification of baseline may be necessary at regular intervals.

1. A method for determining a physical property of an object having opposed first and second end faces and a side face extending between the first and second end faces, the method comprising
taking a first pair of images of the first end face and of a predetermined portion of the side face of the object, so that the first pair of images allow stereo imaging of the object,
taking a second pair of images of the second end face and of the predetermined portion of the side face of the object, so that the second pair of images allow stereo imaging of the object,
using the first and second pair of images for determining the physical property of the object.

2. A method according to claim 1 wherein the object is a log or a piece of processed wood.

3. A method according to claim 1 or 2 wherein the predetermined portion is the upper side of the object.

4. A method according to any one of the preceding claims wherein the object is one of a plurality of objects arranged lying in a side-by-side relationship with each object having its first and second ends and the predetermined portion exposed, and each of the first and second pairs of images includes a plurality of the objects.

5. A method according to claim 4, wherein a first series of first pairs of images is taken that allow stereo imaging of the plurality of objects, and a second series of second pairs of images is taken that allow stereo imaging of the plurality of objects.

6. A method according to claim 5, wherein the first and second series are taken using a camera that is moved relative to the plurality of objects.

7. A method according to claim 5, wherein the first and second series are taken using a stationary camera and moving the plurality of objects relative to the camera.

8. A method according to any one of claims 1-7, wherein each pair of images is taken using a pair of cameras.

9. A method according to any one of claims 1-7, wherein each pair of images is taken using a single camera.

10. A method according to any one of claims 2-9, wherein the physical property is selected from the group comprising length, diameter, volume, shape, curvature, surface irregularities, species of tree, percentage of bark, percentage of wood, damage, percentage of rot.

11. A system for determining a physical property of an object having opposed first and second end faces and a side face extending between the first and second end faces, the system comprising
means for taking a first pair of images of the first end face and of a predetermined portion of the side face of the object, so that the first pair of images allow stereo imaging of the object,
means for taking a second pair of images of the second end face and of the predetermined portion of the side face of the object, so that the second pair of images allow stereo imaging of the object,
means for using the first and second pair of images for determining the physical property of the object.
